(19) United States
(12) Patent Application Publication
(10) Pub. No.: US 2023/0261259 A1
(43) Pub. Date: Aug. 17, 2023

(54) ELECTROLYTE, SECONDARY CELL, AND COMPOSITE MATERIAL

(71) Applicant: TOHOKU UNIVERSITY, Miyagi (JP)

(72) Inventors: Hiroshi Yabu, Miyagi (JP); Shin-ichi Orimo, Miyagi (JP); Kazuaki Kisu, Miyagi (JP); Manjit Singh Grewal, Miyagi (JP)

(21) Appl. No.: 18/002,650

(22) PCT Filed: Jun. 28, 2021
(86) PCT No.: PCT/JP2021/024284

§ 371 Date: Dec. 20, 2022

(30) Foreign Application Priority Data
Jun. 29, 2020 (JP) 2020-111816

(51) Int. Cl. H01M 10/0565

(52) U.S. Cl. CPC H01M 10/0565; H01M 2300/0082

(57) ABSTRACT

An object is to provide an electrolyte having stretchability and flexibility and capable of preventing a decrease in durability of the electrolyte, a secondary cell, and a composite material. The object can be implemented with an electrolyte containing: a polymer obtained by polymerizing a monomer represented by the following Formula (1) (In Formula (1), R₁ and R₂ each independently represent H or a linear, branched, or cyclic alkyl group having 1 to 20 carbon atoms. X₁ and X₂ each independently represent O or NH. When X₂ is O, n represents an integer of 0 to 30 on average, and when X₂ is NH, n represents an integer of 1 to 30 on average.); a glyme represented by the following Formula (2) (In Formula (2), R₃ and R₄ each independently represent an alkyl group having 1 to 4 carbon atoms, and m represents an integer of 1 to 4.); and at least one salt selected from the group consisting of a lithium salt, a sodium salt, a magnesium salt, a potassium salt, and a calcium salt.

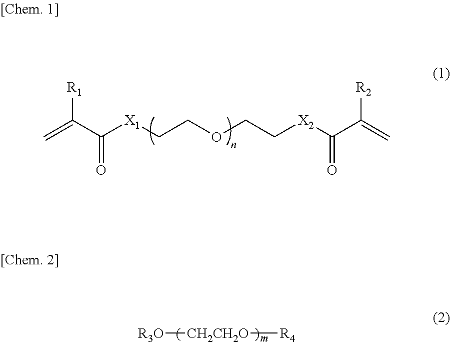

### TECHNICAL FIELD

The present invention relates to an electrolyte, a secondary cell, and a composite material.

### BACKGROUND ART

Lithium-ion cells have a high energy density, and thus are used as a power source for portable electronic devices, such as notebook computers and mobile phones, and automobiles. Further, the use of the lithium-ion cell is expected to expand in the future, and is expected to develop to new applications.

Liquid electrolytes have been used as electrolytes for lithium ion cells in related art. However, in the lithium-ion cell using the liquid electrolyte, when a temperature of the cell rises due to any abnormality, an electrolytic solution may ignite. In addition, there is a possibility that the electrolyte vaporizes, a pressure in the cell increases, and the cell ruptures.

It is required to further improve safety by preventing the ignition and rupture of the lithium-ion cell. Therefore, in order to improve safety, it has been proposed to use a solid electrolyte as the electrolyte of the lithium-ion cell, and research and development have been conducted.

Examples of the solid electrolyte include an electrolyte using a polymer and an inorganic solid electrolyte. In particular, the electrolyte using a polymer can be easily produced by applying and polymerizing an electrolyte composition containing a monomer. In addition, the electrolyte using a polymer is more excellent in moldability and processability than the inorganic solid electrolyte, and can be used particularly for an application requiring flexibility. Further, due to a high degree of freedom in shape and easy laminating, improvement in output density and energy density can be expected.

### CITATION LIST

### Patent Literature

PTL 1: JP-A-2016-197590
PTL 2: JP-A-2009-176523

### SUMMARY OF INVENTION

### Technical Problem

PTLs 1 and 2 disclose an electrolyte using a polymer. The electrolyte using a polymer can be used in various shapes due to stretchability and flexibility thereof, but when the electrolyte is used while maintaining a shape as it is, a large stress is applied to the electrolyte. As a result, durability of the electrolyte may decrease due to breakage, thinning, or the like of the electrolyte. Therefore, there is a demand for an electrolyte having stretchability and flexibility as compared with the electrolyte in the related art.

Therefore, an object of the present application is to provide an electrolyte, a secondary cell, and a composite material having stretchability and flexibility and capable of preventing a decrease in durability of the electrolyte. Other optional additional effects of the disclosure in the present application will become apparent in the embodiments of the invention.

### Solution to Problem

(1) An electrolyte containing: a polymer obtained by polymerizing a monomer represented by the following Formula (1)

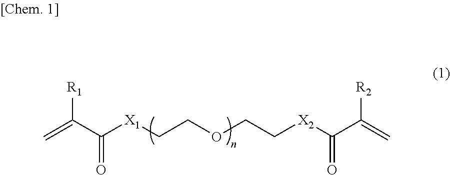

(In Formula (1), R₁ and R₂ each independently represent H or a linear, branched, or cyclic alkyl group having 1 to 20 carbon atoms. X₁ and X₂ each independently represent O or NH. When X₂ is O, n represents an integer of 0 to 30 on average, and when X₂ is NH, n represents an integer of 1 to 30 on average.);

a glyme represented by the following Formula (2)

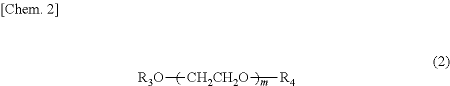

(In Formula (2), R₃ and R₄ each independently represent an alkyl group having 1 to 4 carbon atoms, and m represents an integer of 1 to 4.); and

at least one salt selected from the group consisting of a lithium salt, a sodium salt, a magnesium salt, a potassium salt, and a calcium salt.

(2) The electrolyte according to (1), in which

an anion of the salt is at least one selected from the group consisting of PF₆⁻, BF₄⁻, ClO₄⁻, B(C₂O₄)₂⁻, N(FSO₂)₂⁻,

and N(CF₃SO₂)₂⁻.

(3) The electrolyte according to (2), in which

the anion of the salt is N(FSO₂)₂⁻ or N(CF₃SO₂)⁻.

(4) The electrolyte according to any one of (1) to (3), in which

the salt is a lithium salt.

(5) The electrolyte according to any one of (1) to (4), in which

in Formula (1), when X₂ is O, n is 3 to 14 on average, and when X₂ is NH, n is 4 to 15 on average.

(6) The electrolyte according to any one of (1) to (5), in which

in Formula (2), m is 4.

(7) A secondary cell at least including:

a positive electrode;

a negative electrode; and

an electrolyte layer between the positive electrode and the negative electrode, in which

the electrolyte layer is the electrolyte according to any one of (1) to (6).

(8) A composite material including:

the electrolyte according to any one of (1) to (6); and

a porous carrier.

(9) The composite material according to (8), in which

the porous carrier has a through hole penetrating in a thickness direction.

(10) The composite material according to (8) or (9), in which

the porous carrier is a honeycomb film.

(11) A secondary cell includes:

a positive electrode;

a negative electrode; and

an electrolyte layer between the positive electrode and the negative electrode, in which

the electrolyte layer is the composite material according to any one of (8) to (10).

### Advantageous Effect

An electrolyte having stretchability and flexibility can be provided.

### BRIEF DESCRIPTION OF THE DRAWINGS

FIG. 1 is a schematic cross-sectional view of a cell.

FIG. 2 is a graph showing temperature dependence of ionic conductivities of electrolytes 1 to 4.

A of FIG. 3 is a graph showing mechanical properties of electrolyte 1 produced in Example 1. B of FIG. 3 is a photograph in place of a drawing, and is a photograph when electrolyte 4 produced in Example 4 was deformed.

FIG. 4 is a graph showing charge and discharge characteristics of electrolyte 1.

FIG. 5 is a graph showing results of linear sweep voltammetry of electrolyte 1.

A of FIG. 6 is a graph showing results of chronoamperometry of electrolyte 1. B of FIG. 6 is a graph showing results of AC impedance measurements of electrolyte 1.

FIG. 7 is a photograph in place of a drawing of a honeycomb film as viewed from a thickness direction.

FIG. 8 is a graph showing temperature dependence of ionic conductivities of a composite material 1.

FIG. 9 shows graphs showing charge and discharge characteristics of the composite material 1. A of FIG. 7 shows the charge and discharge characteristics during a measurement time of 0 to 100 hours. B of FIG. 7 shows the charge and discharge characteristics during a measurement time of 600 to 700 hours.

FIG. 10 is a graph showing results of linear sweep voltammetry of the composite material 1.

A of FIG. 11 is a graph showing results of chronoamperometry of the composite material 1. B of FIG. 11 is a graph showing results of AC impedance measurements of the composite material 1.

A of FIG. 12 is a photograph showing electrolyte 5 as a photograph in place of a drawing. B of FIG. 12 is a photograph showing electrolyte 9 as a photograph in place of a drawing. C of FIG. 12 is a photograph showing electrolyte 13 as a photograph in place of a drawing.

A of FIG. 13 is a graph showing temperature dependence of ionic conductivities of electrolytes 5 to 8. B of FIG. 13 is a graph showing temperature dependence of ionic conductivities of electrolytes 9 to 12. C of FIG. 13 is a graph showing temperature dependence of an ionic conductivity of electrolyte 13.

### DETAILED DESCRIPTION OF EMBODIMENTS

Electrolytes will be described in more detail below.

In the present specification, a numerical range expressed using “to” means a range including numerical values described before and after “to” as a lower limit value and an upper limit value. In addition, in the present specification, numerical values, numerical ranges, and qualitative expressions (for example, expressions such as “same as” and “the same”) shall be interpreted as indicating numerical values, numerical ranges, and properties including errors generally allowed in the technical field.

### (Embodiment of Electrolyte)

An electrolyte according to an embodiment contains: a polymer obtained by polymerizing a monomer represented by the following Formula (1)

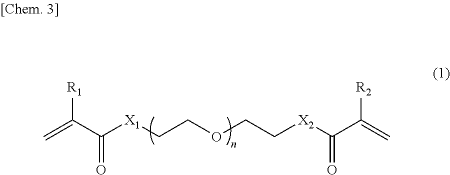

(In Formula (1), R₁ and R₂ each independently represent H or a linear, branched, or cyclic alkyl group having 1 to 20 carbon atoms. X₁ and X₂ each independently represent O or NH. When X₂ is O, n represents an integer of 0 to 30 on average, and when X₂ is NH, n represents an integer of 1 to 30 on average.);

a glyme represented by the following Formula (2)

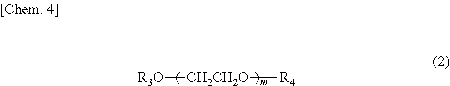

(In Formula (2), R₃ and R₄ each independently represent an alkyl group having 1 to 4 carbon atoms, and m represents an integer of 1 to 4.); and

at least one salt selected from the group consisting of a lithium salt, a sodium salt, a magnesium salt, a potassium salt, and a calcium salt.

The electrolyte is produced by polymerizing a composition containing the monomer represented by Formula (1), the glyme, and the salt. Materials necessary for the production of the electrolyte will be described below.

### [Monomer Represented by Formula (1)]

In the electrolyte, the polymer obtained by polymerizing the monomer represented by Formula (1) is used. Since the monomer represented by Formula (1) has polymerizable groups at both ends, the obtained polymer forms a crosslinked network. In addition, the glyme is a plasticizer. Therefore, the polymer is a plasticized crosslinked network polymer containing oxyethylene.

In Formula (1), R₁ and R₂ each independently represent H or an alkyl group having 1 to 20 carbon atoms. R₁ and R₂ may be the same or different. The alkyl group having 1 to 20 carbon atoms may be linear, branched, or cyclic. Each of R₁ and R₂ is preferably H or an alkyl group having 1 to 5 carbon atoms, more preferably H or a linear alkyl group having 3 or fewer carbon atoms, and still more preferably H or CH₃.

X₁ and X₂ each independently represent O or NH. In addition, X₁ and X₂ may be the same or different.

When X₂ is O, n is in the range of 0 to 30 on average, preferably in a range of 1 to 20 on average, and more preferably in a range of 3 to 14 on average. When X₂ is NH, n is in the range of 1 to 30 on average, preferably in a range of 2 to 20 on average, and more preferably in a range of 4 to 15 on average.

More specifically, when X₂ is O, a minimum value of n may be 0 or more, 1 or more, 2 or more, 3 or more, 4 or more, 5 or more, 6 or more, 7 or more, 8 or more, 9 or more, 10 or more, 11 or more, 12 or more, 13 or more, 14 or more, 15 or more, 16 or more, 17 or more, 18 or more, 19 or more, or 20 or more on average, and a maximum value of n may be 30 or less, 29 or less, 28 or less, 27 or less, 26 or less, 25 or less, 24 or less, 23 or less, 22 or less, 21 or less, 20 or less, 19 or less, 18 or less, 17 or less, 16 or less, 15 or less, 14 or less, 13 or less, 12 or less, 11 or less, or 10 or less on average. In addition, when X₂ is NH, the minimum value of n may be 1 or more, 2 or more, 3 or more, 4 or more, 5 or more, 6 or more, 7 or more, 8 or more, 9 or more, 10 or more, 11 or more, 12 or more, 13 or more, 14 or more, 15 or more, 16 or more, 17 or more, 18 or more, 19 or more, or 20 or more on average, and the maximum value of n may be 30 or less, 29 or less, 28 or less, 27 or less, 26 or less, 25 or less, 24 or less, 23 or less, 22 or less, 21 or less, 20 or less, 19 or less, 18 or less, 17 or less, 16 or less, 15 or less, 14 or less, 13 or less, 12 or less, 11 or less, or 10 or less on average. The range of n may be freely selected in a manner in which the minimum value and the maximum value of n described above do not overlap each other.

The monomer represented by Formula (1) is preferably a liquid at room temperature. When the monomer is a liquid, glyme or a salt can be dissolved in the monomer without requiring a solvent during the production of the electrolyte.

Since the monomer represented by Formula (1) contains an oxyethylene unit in the monomer, stretchability and flexibility of the polymerized polymer are improved. The oxyethylene unit of the polymerized polymer forms a solvation structure with cations of the salt. Therefore, the polymer can contain many cations, and the electrolyte has a high ionic conductivity.

When an amount of the oxyethylene units in the monomer is small, the following problems occur.

1) The amount of the oxyethylene units is reduced, and the stretchability and flexibility of the polymer are reduced.

2) An amount of the cations that can be contained in the polymer decreases.

3) Solubility of the glyme or salt contained during the production of the electrolyte is lowered.

On the other hand, when the amount of the oxyethylene units in the monomer is large, although the stretchability and flexibility of the polymer and the solubility of the glyme and salt become high, a crosslink density becomes small, and it becomes difficult to maintain mechanical properties of the polymer.

Specific examples of the monomer represented by Formula (1) include poly(ethylene glycol) di(meth)acrylate and poly(ethylene glycol) di(meth)acrylamide. An average molecular weight of the monomer represented by Formula (1) is in a range of 200 to 1500, preferably in a range of 240 to 1100, and more preferably in a range of 320 to 800.

In the present specification, “(meth)acrylate” is a concept including both “acrylate” and “methacrylate”. The same also applies to terms similar to (meth)acrylate, for example, “(meth)acrylic acid” is a concept including both “acrylic acid” and “methacrylic acid”, “(meth)acryloyl group” is a concept including both “acryloyl group” and “methacryloyl group”, and “(meth)acrylamide” is a concept including both “acrylamide” and “methacrylamide”.

In the composition during the production of the electrolyte, a content of the monomer represented by Formula (1) is not particularly limited, but is 10% by weight or more, more preferably 20% by weight or more, and still more preferably 30% by weight or more based on a total amount of the composition. The content of the monomer is 90% by weight or less, preferably 80% by weight or less, based on the total amount of the composition.

### [Glyme]

The glyme represented by Formula (2) is used as the plasticizer, and plasticizes the polymer obtained by polymerizing the monomer represented by Formula (1).

In Formula (2), R₃ and R₄ each independently represent an alkyl group having 1 to 4 carbon atoms, and m represents an integer of 1 to 4.

Examples of the alkyl groups of R₃ and R₄ include a methyl group, an ethyl group, an n-propyl group, an isopropyl group, an n-butyl group, an isobutyl group, and a t-butyl group. In particular, a methyl group or an ethyl group is preferable.

In Formula (2), m is an integer of 1 to 4, preferably 3 or 4, and more preferably 4. Specific examples of the glyme represented by Formula (2) include monoglyme (also referred to as ethylene glycol dimethyl ether), diglyme (also referred to as diethylene glycol dimethyl ether), triglyme (also referred to as triethylene glycol dimethyl ether), and tetraglyme (also referred to as tetraethylene glycol dimethyl ether). Among these, triglyme or tetraglyme is preferable, and tetraglyme is more preferable.

In the composition during the production of the electrolyte, a content of the glyme is not particularly limited, but is 5% by weight or more and 50% by weight or less, preferably 10% by weight or more and 20% by weight or less based on the total amount of the composition.

### [Salt]

The salt contained in the electrolyte is an electrolyte salt. The salt may be a lithium salt, a sodium salt, a magnesium salt, a potassium salt, or a calcium salt.

Examples of an anion of the salt include halide ions (I⁻, Cl⁻, Br⁻, or the like), SCN⁻, BF₄⁻, BF₃(CF₃)⁻, BF₃(C₂F₅)⁻, BF₃(C₃F₇)⁻, BF₃(C₄F₉)⁻, PF₆⁻, ClO₄, SbF₆⁻, N(FSO₂)₂⁻ (also referred to as [FIS]⁻), N(CF₃SO₂)₂⁻ (also referred to as [TFSI]⁻), N(C₂F₅SO₂)₂, BPh₄⁻, B(C₂H₄O₂)⁻, C(SO₂F)₃⁻ (also referred to as [f3C]⁻), C(SO₂CF₃)₃⁻, CF₃COO⁻, CF₃SO₂O⁻, C₆F₅SO₂O⁻, and B(C₂O₄)₂⁻ (also referred to as [BOB]⁻), and RCOO⁻ (R represents an alkyl group having 1 to 4 carbon atoms, a phenyl group, or a naphthyl group.). Among these, PF₆⁻, BF₄⁻, [FSI]⁻, [TFSI]⁻, [BOB]⁻, and ClO₄⁻ are preferable, and [FSI]⁻, [TFSI]⁻ are more preferable.

Examples of the lithium salt as the salt include LiPF₆, LiBF₄, Li[FSI], Li[TFSI], Li[f3C], Li[BOB], LiClO₄, LiBF₃(CF₃), LiBF₃(C₂F₅), LiBF₃(C₃F₇), LiBF₃(C₄F₉), LiC(SO₂CF₃)₃, LiCF₃SO₂O, LiCF₃COO, and LiRCOO (R represents an alkyl group having 1 to 4 carbon atoms, a phenyl group, or a naphthyl group.). These lithium salts may be used alone or in combination of two or more kinds thereof.

Examples of the sodium salt as the salt include NaPF₆, NaBF₄, Na[FSI], Na[TFSI], Na[f3C], Na[BOB], NaClO₄, NaBF₃(CF₃), NaBF₃(C₂F₅), NaBF₃(C₃F₇), NaBF₃(C₄F₉), NaC(SO₂CF₃)₃, NaCF₃SO₂O, NaCF₃COO, and NaRCOO (R represents an alkyl group having 1 to 4 carbon atoms, a phenyl group, or a naphthyl group.). These sodium salts may be used alone or in combination of two or more kinds thereof.

Examples of the magnesium salt as the salt include Mg(PF₆)₂, Mg(BF₄)₂, Mg[FSI]₂, Mg[TFSI]₂, Mg[f3C]₂, Mg[BOB]₂, Mg(ClO₄)₂, Mg[BF₃(CF₃)]₂, Mg[BF₃(C₂F₅)]₂, Mg[BF₃(C₃F₇)]₂, Mg[BF₃(C₄F₉)]₂, Mg[C(SO₂CF₃)₃]₂, Mg(CF₃SO₂O)₂, Mg(CF₃COO)₂, and Mg(RCOO)₂ (R represents an alkyl group having 1 to 4 carbon atoms, a phenyl group, or a naphthyl group.). These magnesium salts may be used alone or in combination of two or more kinds thereof.

Examples of the potassium salt as the salt include KPF₆, KBF₄, K[FSI], K[TFSI], K[f3C], K[BOB], KClO₄, KBF₃(CF₃), KBF₃(C₂F₅), KBF₃(C₃F₇), KBF₃(C₄F₉), KC(SO₂CF₃)₃, KCF₃SO₂O, KCF₃COO, and KRCOO (R represents an alkyl group having 1 to 4 carbon atoms, a phenyl group, or a naphthyl group.). These potassium salts may be used alone or in combination of two or more kinds thereof.

Examples of the calcium salt as the salt include Ca(PF₆)₂, Ca(BF₄)₂, Ca[FSI]₂, Ca[TFSI]₂, Ca[f3C]₂, Ca[BOB]₂, Ca(ClO₄)₂, Ca[BF₃(CF₃)]₂, Ca[BF₃(C₂F₅)]₂, Ca[BF₃(C₃F₇)]₂, Ca[BF₃(C₄F₉)]₂, Ca[C(SO₂CF₃)_{3]2}, Ca(CF₃SO₂O)₂, Ca(CF₃COO)₂, and Ca(RCOO)₂ (R represents an alkyl group having 1 to 4 carbon atoms, a phenyl group, or a naphthyl group.). These calcium salts may be used alone or in combination of two or more kinds thereof.

Among these, from the viewpoint of the ionic conductivity, the salt is preferably a lithium salt, more preferably LiPF₆, LiBF₄, Li[FSI], Li[TFSI], Li[f3C], Li[BOB] or LiClO₄, and still more preferably Li[FSI] or Li[TFSI].

“Oxygen of ethylene oxide of polymer” and “cation of salt” form a solvation structure. Therefore, a maximum value of a content of the salt depends on the number of ethylene oxide units of the polymer. Therefore, the content of the salt in the composition during the production of the electrolyte is not particularly limited as long as the number of moles of the salt is smaller than the number of moles of the ethylene oxide units of the polymer.

### [Polymerization Initiator]

The electrolyte according to the embodiment is produced by polymerizing the monomer represented by Formula (1). At this time, a polymerization initiator is used. The polymerization initiator is not particularly limited as long as the polymerization initiator can cause the oization of the monomer represented by Formula (1). Polymerization initiators includes photopolymerization initiators and thermal polymerization initiators, and the photopolymerization initiators are cured faster than the thermal polymerization initiators. In addition, the photopolymerization initiators include photoradical polymerization initiators, photoanionic polymerization initiators, and photocationic polymerization initiators. The photoradical polymerization initiators perform a rapid addition reaction to a double bond, and thus do not generate impurities caused by the reaction. When the reaction causing the polymerization is slow during the production of the electrolyte, molecules in the obtained polymer may be easily aligned and crystallized. Therefore, it is important to rapidly perform the polymerization reaction during the production of the electrolyte. In addition, when no impurities are generated, it is not necessary to remove the impurities after the polymerization reaction, and a production process of the electrolyte can be simplified.

Therefore, it is preferable to use a photoradical polymerization initiator in the polymerization reaction of the monomer represented by Formula (1). The crosslinked network polymer formed by the photoradical polymerization initiator is polymerized before molecules in the polymer are aligned since the polymerization reaction is fast. That is, the crosslinked network polymer is formed in an amorphous state.

The photoradical polymerization initiator is not particularly limited as long as the monomer is polymerized, and examples thereof include an acetophenone-based photoradical polymerization initiator, a benzophenone-based photoradical polymerization initiator, a thioxanthone-based photoradical polymerization initiator, and an acylphosphine-based photoradical polymerization initiator. Specifically, 2,2-dimethoxy-2-phenylacetophenone, benzophenone, benzoylbenzoic acid, 2,2-diethoxyacetophenone, 2,4-diethyl-9H-thioxanthen-9-one, 4,4′-dimethoxybenzyl, diphenyl(2,4,6-trimethylbenzoyl)phosphine oxide, 2-ethoxy-2-phenylacetone, 2-ethylanthraquinone, 1-hydroxycyclohexyl phenyl ketone, 2-(hydroxyimino)propiophenone, 2-hydroxy-2-phenylacetophenone, 2-methyl-4′-(methylthio)-2-morpholinopropiophenone, and p,p′-tetramethyldiaminobenzophenone are preferable, and 2,2-dimethoxy-2-phenylacetophenone is more preferable.

A usage amount of the polymerization initiator is not particularly limited, but is, for example, 0.001 parts by weight to 0.1 parts by weight, and preferably 0.005 parts by weight to 0.01 parts by weight, with respect to 100 parts by weight of the monomer.

The electrolyte can be produced by mixing the monomer represented by Formula (1), the glyme represented by Formula (2), the salt, and the polymerization initiator to cause the polymerization. The monomer represented by Formula (1) is a liquid at room temperature as described above, and thus can dissolve the glyme, the salt, and the polymerization initiator. Therefore, the electrolyte does not require the solvent. In addition, the composition in which the above materials are mixed is only irradiated with light such as ultraviolet rays or an electron beam, and does not need a heat treatment or the like for stabilizing a structure thereof after the polymerization. Therefore, the electrolyte can be easily produced.

The electrolyte according to the embodiment has the following effects.

(1) Since the electrolyte according to the embodiment is a plasticized crosslinked network polymer, the electrolyte has stretchability and flexibility, and also has sufficient mechanical strength. Therefore, it is possible to prevent an operation of a stress generated when the electrolyte is bent, stretched, or changed in shape. Therefore, it is possible to prevent a decrease in durability of the electrolyte due to breakage, thinning, or the like of the electrolyte.

(2) The electrolyte according to the embodiment is a plasticized crosslinked network polymer, and has sufficient oxyethylene units. The oxyethylene unit forms the solvation structure with cations of the salt, and thus a large amount of cations can be contained in the electrolyte. Therefore, the electrolyte has a high ionic conductivity.

(3) In the electrolyte according to the embodiment, as the number of oxyethylene units increases, the stretchability and flexibility are improved. In addition, a content of the cation of the salt also increases. Therefore, by increasing n of the monomer represented by Formula (1), the above effects (1) and (2) can be synergistically obtained.

(4) In general, in an electrolyte using a polymer, it is known that an ionic conductivity decreases when the polymer has a crystal structure. During the production of the electrolyte according to the embodiment, the polymerization is performed before the polymer is crystallized when the photoradical polymerization initiator having a high reaction speed is used. Therefore, the electrolyte is in the amorphous state, and the decrease in ionic conductivity can be prevented.

(5) The electrolyte according to the embodiment can be produced without using a solvent. For example, when an organic solvent is used, the organic solvent is easily volatilized, and thus it is difficult to handle the organic solvent during the production of the electrolyte. In addition, depending on types of the polymer of the electrolyte and the organic solvent, the polymer and the solvent are separated from each other, resulting in a problem that the ionic conductivity and the mechanical strength of the electrolyte are significantly reduced. However, since the electrolyte according to the embodiment does not use a solvent, the above-described problem does not occur.

### (Embodiment of Composite Material)

The electrolyte according to the above embodiment can also be used for a composite material. The composite material includes the electrolyte and a porous carrier.

The porous carrier has apertures and carries the electrolyte in the apertures. Therefore, when the composite material is used for a secondary cell, the porous carrier ensures an ionic conductivity while separating a positive electrode and a negative electrode from each other. In addition, since the electrolyte is carried by the porous carrier, diffusion of ions is prevented. Therefore, the porous carrier has a function as a separator.

A structure of the porous carrier is not particularly limited as long as the porous carrier carries the electrolyte and has apertures capable of securing the ionic conductivity between the positive electrode and the negative electrode in the secondary cell. The structure of the porous carrier may have, for example, regularly arranged apertures or random apertures. When the porous carrier has regularly arranged apertures, the porous carrier may be, for example, a honeycomb film having apertures of a honeycomb structure. The honeycomb structure may be implemented with, for example, stereoscopic bodies each having a columnar shape such as a polygonal column or a cylinder, a conical shape such as a pyramid or a cone, a spherical shape, or an ellipsoidal shape that are arranged without gaps on any plane. In addition, the honeycomb film may be implemented with a single layer in which the stereoscopic bodies are arranged without gaps, or may be implemented by laminating a plurality of layers in a direction perpendicular to any plane. Examples of the porous carrier having random apertures include a nonwoven fabric, a uniaxially stretched porous film, a biaxially stretched porous film, and a particle mold porous film.

The apertures of the porous carrier have a size in a range of 0.1 μm to 60 μm. More specifically, the aperture may be 0.1 μm or more, 0.2 μm or more, 0.3 μm or more, 0.4 μm or more, 0.5 μm or more, 0.6 μm or more, 0.7 μm or more, 0.8 μm or more, 0.9 μm or more, 1 μm or more, 2 μm or more, 3 μm or more, 4 μm or more, 5 μm or more, 6 μm or more, 7 μm or more, 8 μm or more, 9 μm or more, 10 μm or more, 11 μm or more, 12 μm or more, 13 μm or more, 14 μm or more, 15 μm or more, 16 μm or more, 17 μm or more, 18 μm or more, 19 μm or more, or 20 μm or more. The aperture may be 60 μm or less, 59 μm or less, 58 μm or less, 57 μm or less, 56 μm or less, 55 μm or less, 54 μm or less, 53 μm or less, 52 μm or less, 51 μm or less, 50 μm or less, 49 μm or less, 48 μm or less, 47 μm or less, 46 μm or less, 45 μm or less, 44 μm or less, 43 μm or less, 42 μm or less, 41 μm or less, 40 μm or less, 39 μm or less, 38 μm or less, 37 μm or less, 36 μm or less, 35 μm or less, 33 μm or less, 32 μm or less, 31 μm or less, 30 μm or less, 29 μm or less, 28 μm or less, 27 μm or less, 26 μm or less, 25 μm or less, 24 μm or less, 23 μm or less, 22 μm or less, 21 μm or less, or 20 μm or less. The range of the apertures may be freely selected in a manner in which the values described above do not overlap with each other. In the present specification, when the aperture is implemented with the above-described stereoscopic body in the honeycomb film, the size of the aperture is defined as a diameter of a sphere inscribed in the above-described stereoscopic body.

As described above, the porous carrier functions as the separator. The separator ensures the ionic conductivity between the positive electrode and the negative electrode, but by unifying a distribution due to a flow of ions between the positive electrode and the negative electrode, that is, a current distribution, generation of dendrite can be prevented. Therefore, in order to adjust the flow of ions between the positive electrode and the negative electrode and unifying the current distribution, the porous carrier preferably has a through hole in a thickness direction thereof. The through hole provided in the porous carrier refers to a hole communicating with a first surface and a second surface opposite to each other in the thickness direction of the porous carrier. It is sufficient that the first surface and the second surface communicate with each other due to the through hole, for example, the first surface and the second surface may communicate with each other through a plurality of apertures of the porous carrier continuous to one another, or the first surface and the second surface may communicate with each other through one aperture.

The porous carrier is not particularly limited as long as the porous carrier is a material that can form apertures and does not dissolve in the electrolyte. Examples of the porous carrier include: polymers such as polybutadiene, polyisoprene, polystyrene, polycarbonate, polylactic acid, polycaprolactone, polyimide, polyamide, and polyolefin; and inorganic oxides such as silica, titania, and alumina. The porous carrier is not particularly limited as long as the porous carrier can be produced by a method capable of forming apertures. For example, when the honeycomb film as the porous carrier is produced, the honeycomb film may be produced by breath figure or the like (SCIENCE AND TECHNOLOGY OF ADVANCED MATERIALS, 2018, VOL. 19, No. 1, 802 to 822).

The electrolyte according to the above embodiment is a plasticized crosslinked network polymer. Therefore, in order to produce the composite material, a known method may be used as long as the method can cause the porous carrier to carry the polymer. For example, the composite material may be produced by retaining a composition containing the monomer represented by Formula (1), the glyme, and the salt in the apertures of the porous carrier by impregnating the composition, coating the composition, or the like, and polymerizing the composition.

The composite material according to the embodiment synergistically exhibits the following effects in addition to the effects exhibited by the electrolyte according to the embodiment.

(1) In the composite material, since the electrolyte is carried by the porous carrier, mechanical properties such as the mechanical strength and thermal stability are improved.

(2) When the through hole is provided in the thickness direction of the porous carrier, the flow of ions is adjusted. Therefore, the composite material has a high ionic conductivity. In addition, the current distribution can be unified, and the generation of the dendrite can be prevented.

(3) When the porous carrier is a honeycomb film, since the apertures are regularly arranged without gaps, the structure of the composite material is unified, and the flow of ions is easily controlled.

(4) Even when dendrite is generated, the composite material can prevent penetration of the dendrite.

### (Embodiment of Secondary Cell)

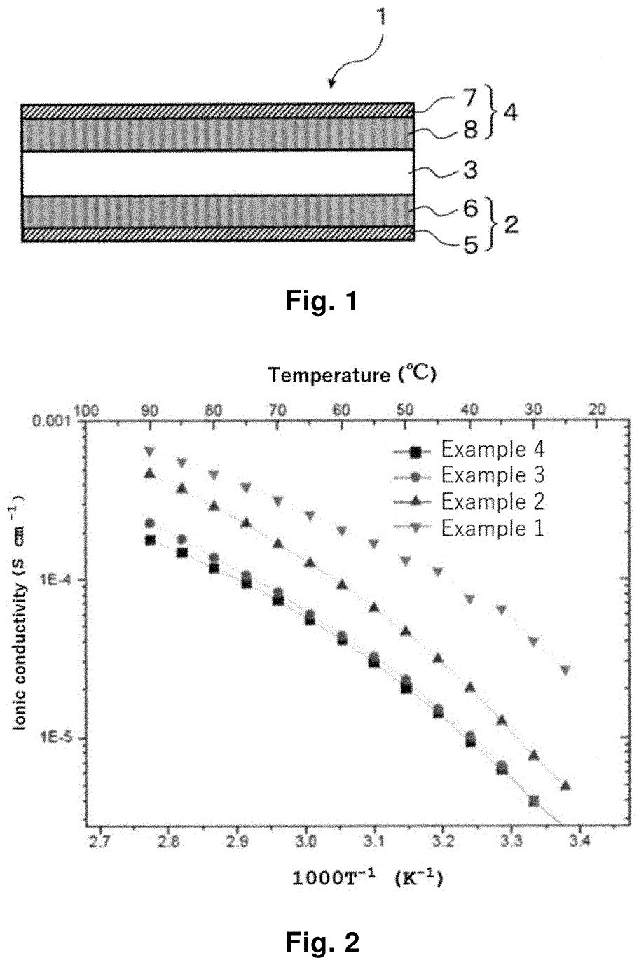

A secondary cell will be described with reference to FIG. 1. FIG. 1 is a schematic cross-sectional view of the secondary cell. A secondary cell 1 includes a positive electrode 2, an electrolyte layer 3, and a negative electrode 4 in this order. The positive electrode 2 includes a positive electrode current collector 5 and a positive electrode active material layer 6. The negative electrode 4 includes a negative electrode current collector 7 and a negative electrode active material layer 8.

The positive electrode current collector 5 may be made of any material as long as the material does not cause a change such as dissolution or oxidation during use of the cell. Examples of the material include aluminum, stainless steel, titanium, and carbon materials. In addition, a shape of the positive electrode current collector 5 is not limited, and examples thereof include a perforated foil, an expanded metal, and a foamed metal plate.

A thickness of the positive electrode current collector 5 may be 1 μm to 100 μm, preferably 5 μm to 50 μm, and more preferably 10 μm to 20 μm.

Examples of a positive electrode active material used for the positive electrode active material layer 6 include LiCoO₂, Li_{0.3}MnO₂, Li₄Mn₅O₁₂, V₂O₅, LiMn₂O₄, LiNiO₂, LiFePO₄, LiCo_{1/3}N_{1/3}Mn_{1/3}O₂, Li_{1.2}(Fe_{0.5}Mn_{0.5}), Li_{1.2} (Fe_{0.4}Mn_{0.4}Ti_{0.2})_{0.8}O₂, Li₁₊ₓ(Ni_{0.5}Mn_{0.5})₁-xO₂ (here, x=0 to 1), LiNi_{0.5}Mn_{1.5}O₄, Li₂MnO₃, Li_{0.76}Mn_{0.51}Ti_{0.49}O₂, LiNi_{0.8}Co_{0.15}Al_{0.05}O₂, Fe₂O₃, LiCoPO₄, LiMnPO₄, Li₂MPO₄F (M=Fe, Mn), LiMn_{0.875}Fe_{0.125}PO₄, Li₂FESiO₄, Li₂₋ₓMSi₁₋ₓPₓO₄ (M=Fe, Mn) (here, x=0 to 1), LiMBO₃ (M=Fe, Mn), FeF₃, Li₃FeF₆, Li₂FeS₂, TiS₂, MoS₂, and FeS.

A thickness of the positive electrode active material layer 6 may be 10 μm to 100 μm, preferably 20 μm to 80 μm, and more preferably 30 μm to 60 μm.

As the electrolyte layer 3, the electrolyte or the composite material according to the embodiment can be used. A thickness of the electrolyte layer 3 may be 1 μm to 200 μm, preferably 3 μm to 100 μm, and more preferably 5 μm to 70 μm. When the thickness is 1 μm or more, a short circuit between the electrodes can be prevented. When the thickness is 200 μm or less, an energy density can be increased.

Examples of a material of the negative electrode current collector 7 include copper, stainless steel, titanium, nickel, and carbon materials. In addition, a shape of the negative electrode current collector 7 is not limited, and examples thereof include a perforated foil, an expanded metal, and a foamed metal plate.

A thickness of the negative electrode current collector 7 may be 1 μm to 100 μm, preferably 5 μm to 50 μm, and more preferably 10 μm to 20 μm.

Examples of a negative electrode active material used for the negative electrode active material layer 8 include metal lithium, a lithium alloy, a metal compound, a carbon material, a metal complex, and an organic polymer compound. Among these, the carbon material is preferable. Examples of the carbon material include: carbon blacks such as graphite, acetylene black, ketjen black, channel black, furnace black, lamp black, and thermal black; amorphous carbon; and carbon fibers.

The secondary cell in which the electrolyte or the composite material according to the embodiment is used for the electrolyte layer 3 can improve mechanical durability by the electrolyte or the composite material, and can have a long life by being capable of containing a large amount of cations in the electrolyte.

Hereinafter, the embodiment disclosed in the present application will be specifically described with reference to examples, but the examples are merely for describing the embodiment. It is not intended to limit or restrict the scope of the invention disclosed in the present application.

### EXAMPLES

### Example 1

### [Production of Electrolyte 1]

The electrolyte was produced by a procedure described below.

### [Materials]

Poly(ethylene glycol) diacrylate (PEGDA; average molecular weight: 700 (n is up to 13), manufactured by Sigma-Aldrich Corporation) 0.2 ml (0.36 mol)
Tetraglyme (manufactured by Sigma-Aldrich
Corporation)_{0.17} ml (0.77 mol) Li[TFSI] (manufactured by Kanto Chemical Co., Ltd.) 0.22 g (0.77 mol)

### [Production Method]

The above materials were mixed in a glass vial and stirred overnight. DMPA (7.32 mg) was added to the solution, and the mixture was further stirred for 2 hours. Next, this solution was transferred onto glass, and was subjected to photopolymerization by being exposed (365 nm, 20 W) five times every 5 minutes on front and back surfaces with a UV lamp (chibi Light DX BOX-S1100). Thereafter, a cured product was peeled off from the glass, and was dried in a vacuum oven at 60° C. for 24 hours to produce electrolyte 1.

In the obtained electrolyte 1, a ratio ([EO]/[Li⁺]) of the number of moles of the ethylene oxide units to the number of moles of lithium ions in the electrolyte is 6.

### Example 2

### [Production of Electrolyte 2]

Electrolyte 2 was produced in the same procedure as in Example 1, except that the amount of PEGDA was changed to 0.4 ml (0.71 mol) during the production of the electrolyte. [EO]/[Li⁺] of the obtained electrolyte is 12.

### Example 3

### [Production of Electrolyte 3]

Electrolyte 3 was produced in the same procedure as in Example 1, except that the amount of PEGDA was changed to 0.7 ml (1.07 mol) during the production of the electrolyte. [EO]/[Li⁺] of the obtained electrolyte is 18.

### Example 4

### [Production of Electrolyte 4]

Electrolyte 4 was produced in the same procedure as in Example 1, except that the amount of PEGDA was changed to 0.9 ml (1.43 mol) during the production of the electrolyte. [EO]/[Li⁺] of the obtained electrolyte is 24.

### Example 5

### [Temperature Dependence of Ionic Conductivities of Electrolytes 1 to 4]

Ionic conductivities of electrolytes 1 to 4 produced in Examples 1 to 4 were measured at a plurality of temperatures. A sample in which an electrolyte (a circle having a diameter of 8 mm) was sandwiched between two stainless steel (SUS304, manufactured by The Nilaco Corporation) electrodes was disposed in a cell assembly (manufactured by Hohsen Corp.), and the ionic conductivity was measured using an AC impedance measurement device (Hioki 3532-80 LCR HiTester). The measurement was performed in a temperature range of 25° C. to 90° C. at a temperature interval of 5° C. For thermal equilibrium and data reproducibility, a sufficient time was spared at each temperature.

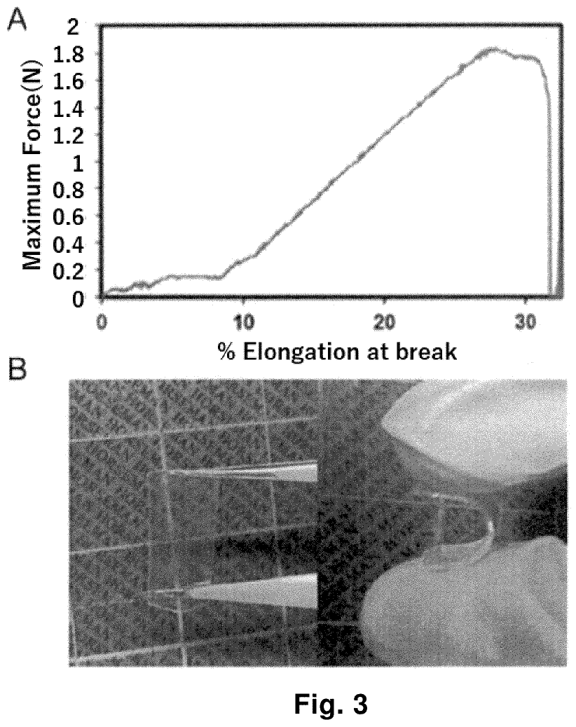

The ionic conductivities of electrolytes 1 to 4 produced in Examples 1 to 4 measured at the respective temperatures are shown in FIG. 2. Electrolytes 1 to 4 exhibited linearity in a measurement range. In addition, it was shown that electrolytes 1 to 4 had sufficient ionic conductivities. In addition, it was shown that a higher content of lithium ions in the electrolyte causes a higher ionic conductivity.

### Example 6

### [Mechanical Properties of Electrolyte]

A tensile/force-displacement measurement was performed on electrolyte 1 produced in Example 1. Electrolyte 1 having a substantially rectangular shape of 30 mm×10 mm and a thickness of about 0.4 mm was used as a sample, and the measurement was performed by using a measurement stand (manufactured by Imada Co., Ltd.) and performing separation at room temperature in a vertical direction from the measurement stand on which the sample was disposed at an extension speed of 1.0 mm/min.

Results are shown in A of FIG. 3. According to A of FIG. 3, it was shown that electrolyte 1 had an elongation of about 30% and had a good mechanical property in elongation. Therefore, an influence of a stress applied to the electrolyte can be prevented. In addition, according to A of FIG. 3, electrolyte 1 elongated by about 10% with a small force. That is, it is indicated that electrolyte 1 is easily deformed even with a small force. When the electrolyte is used in a secondary cell, the electrolyte expands and contracts due to a temperature change and charging and discharging due to use of the secondary cell, and a load is applied to the electrolyte. However, since electrolyte 1 can be deformed even with a small force, it is expected that an influence of the temperature change and the charging and discharging is reduced and the load on the electrolyte is reduced. Furthermore, since the electrolyte is flexibly deformed with a small force, it is also expected to avoid a short circuit between the electrodes and reduce a risk of ignition.

B of FIG. 3 shows results of an experiment in which the produced electrolyte 4 was elongated with tweezers and an experiment in which electrolyte 4 was bent. As in A of FIG. 3, it was confirmed that the electrolyte elongated well.

### Example 7

### [Charge and Discharge Characteristics of Electrolyte 1]

A polarization test was performed using electrolyte 1 produced in Example 1. In the polarization test, a symmetric cell formed of Li/electrolyte 1/Li was used, and steps of charging and discharging were repeated at 60° C. for 30 minutes at a current density of 0.1 mA/cm².

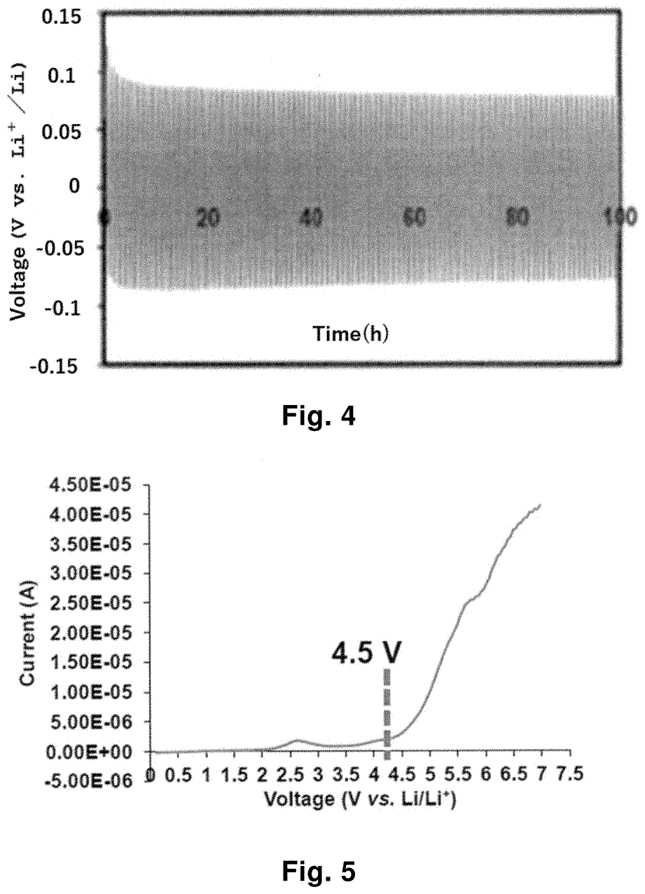

A result of the polarization test is shown in FIG. 4. According to FIG. 4, it was confirmed that the Li/electrolyte 1/Li cell stably performed the charge and discharge even after 100 hours. Further, from FIG. 4, since voltage attenuation is very gentle even after a time elapsed, it is presumed that the cell has stable charge and discharge characteristics even after 100 hours elapsed. Therefore, when electrolyte 1 is used for a secondary cell, it is expected that the secondary cell has a long life.

### Example 8

### [Linear Sweep Voltammetry of Electrolyte 1]

Linear sweep voltammetry (LSV) was performed using electrolyte 1 produced in Example 1.

The measurement was performed by scanning at a rate of 1 mV/s with a scan range of 1.0 V to 7.0 V (vs. Li⁺/Li) using a cell formed of stainless steel (SUS304, manufactured by The Nilaco Corporation)/electrolyte 1/Li. A measurement temperature was 60° C. As a measurement device, 1470E potentiostat/galvanostat (manufactured by Solartron Analytical Corporation) was used.

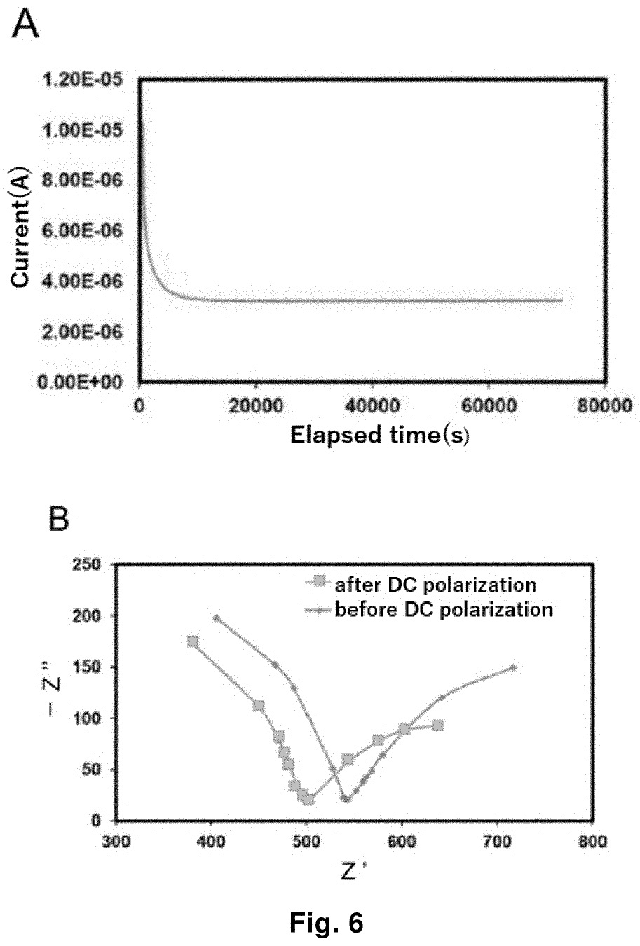

A result is shown in FIG. 5. It was shown from FIG. 5 that electrolyte 1 was stable up to around 4.5 V. Based on the above, it was shown that electrolyte 1 has a wide potential window.

### Example 9

### [Calculation of Lithium-Ion Transference Number of Electrolyte 1]

Chronoamperometry and an AC impedance measurement were performed using electrolyte 1, and a lithium-ion transference number (t_{Li+}) of electrolyte 1 was calculated.

The lithium-ion transference number (t_{Li+}) was calculated by performing the chronoamperometry and the AC impedance measurement using a cell formed of Li/electrolyte 1/Li assembled in a glove box (O₂ and H₂O<0.1 ppm) filled with argon. In the chronoamperometry, a potential of 10 mV was applied to the cell stabilized at 60° C. overnight, and an initial current (I₀) was measured. Thereafter, the potential of 10 mV was continuously applied to the cell, and when a current value reached a steady value, a steady current (Iₛ) was measured. In addition, in the AC impedance measurement, an initial interface resistance (R₀) of the cell stabilized at 60° C. overnight and a steady interface resistance (Rₛ) of the cell in a steady state when the potential of 10 mV was applied were measured. As a measurement device, a frequency response analyzer (1470E, manufactured by Solartron Analytical Corporation) was used. t_{Li+} was calculated from Bruce-Vincent-Evans Formula shown below.

$${t}_{Li +} = \frac{{I}_{s} ( Δ V - {I}_{0} {R}_{0} )}{{I}_{0} ( Δ V - {I}_{s} {R}_{s} )} \qquad [ Equation 1 ]$$

Results of the chronoamperometry are shown in A of FIG. 6. Results of the AC impedance measurement are shown in B of FIG. 6. When t_{Li+} of electrolyte 1 was calculated from the results shown in A and B of FIG. 6, t_{Li+} of electrolyte 1 was 0.30.

### Example 10

### [Production of Composite Material 1]

### [Materials]

1,2-polybutadiene (RB820, manufactured by JSR Corporation)
Surfactant represented by the following Formula (3) (in Formula (3), X is about 0.8, manufactured by Tokyo Chemical Industry Co., Ltd.)
Poly(ethylene glycol) diacrylate (PEGDA; average molecular weight: 700 (n is up to 13), manufactured by Sigma-Aldrich Corporation): 0.9 ml (1.43 mmol)
Tetraglyme (manufactured by Sigma-Aldrich
Corporation)_{0.6819} ml (3.0 mmol) Li[TFSI] (manufactured by Kanto Chemical Co., Ltd.) 0.8886 g (3.0 mmol)

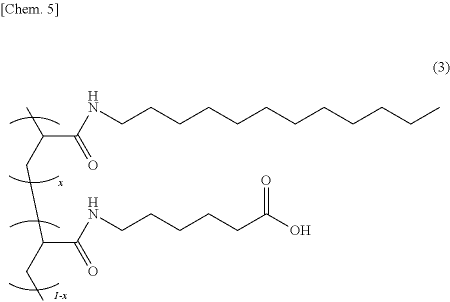

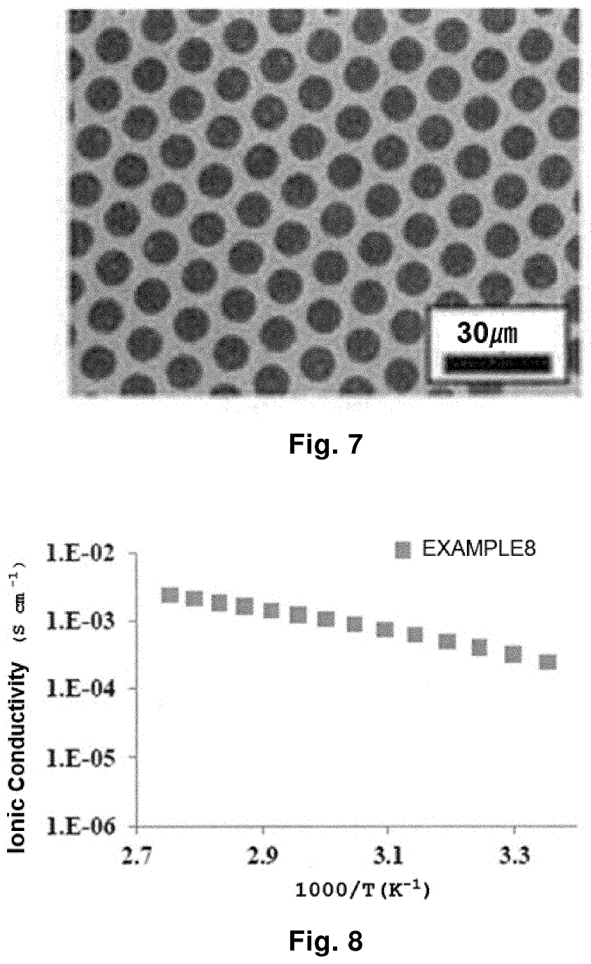

### [Production of Honeycomb Film]

[1] 1,2-polybutadiene and the surfactant represented by Formula (3) were mixed at a weight ratio of 10:1 to prepare a 5.0 mg/ml solution.

[2] The prepared solution was cast on a 10 cm×30 cm glass substrate at each volume of 20 ml, 25 ml, and 45 ml.

[3] By blowing humidified air (relative humidity>90%, flow rate: 130 l/min) to form a film, honeycomb films having pore diameters of 3 μm, 8 μm, and 14 μm were obtained, respectively. FIG. 7 shows a scanning electron micrograph of the honeycomb film having the pore diameter of 3 μm as viewed in a thickness direction. FIG. 7 shows that the honeycomb film had through holes in the thickness direction.

### [Production of Composite Material 1]

[1] The honeycomb film having the pore diameter of 3 μm produced as described above was scooped up in ethanol or water onto a PET film frame cut into a 50 mm square, and dried.

[2] A mixed solution obtained by mixing PEGDA, tetraglyme, LiTFSI, and DMPA (7.32 mg) was applied onto a petri dish, the honeycomb film was placed thereon, and the mixed solution was applied onto the honeycomb film. In the mixed solution, [EO]/[Li⁺] is 6.

[3] The honeycomb film coated with the mixed solution was placed under reduced pressure to remove bubbles and the like from the mixed solution, and subjected to photocrosslinking by UV light (wavelength: 365 nm, 20 W) in the same manner as when the electrolyte is used alone to obtain the composite material 1. The obtained composite material 1 was annealed at 60° C. for 24 hours to complete crosslinking. In addition, introduction of the electrolyte into the through holes was confirmed by observation with a scanning electron microscope.

### Example 11

### [Temperature Dependence of Ionic Conductivity of Composite Material 1]

An ionic conductivity of the composite material 1 produced in Example 10 was measured at a plurality of temperatures. The measurement was performed in the same manner as in Example 5 except that the sample was the composite material 1.

A result is shown in FIG. 8. The composite material 1 exhibited linearity in a measurement range. The composite material 1 had a high ionic conductivity of 10-4 S/cm or more even at room temperature. The reason is considered as that since the electrolyte was carried by the honeycomb film, diffusion of ions was prevented, and the flow of ion conduction was adjusted, so that the ionic conductivity of the composite material 1 was improved.

### Example 12

### [Charge and Discharge Characteristics of Composite Material 1]

A polarization test was performed using the composite material 1 produced in Example 10. In the polarization test, a coin cell formed of Li foil/composite material 1/LiFePO₄ (LFP) electrode was used, and a charge and discharge test at 60° C. was performed by a 580 Battery Test System, Scribner Associates.

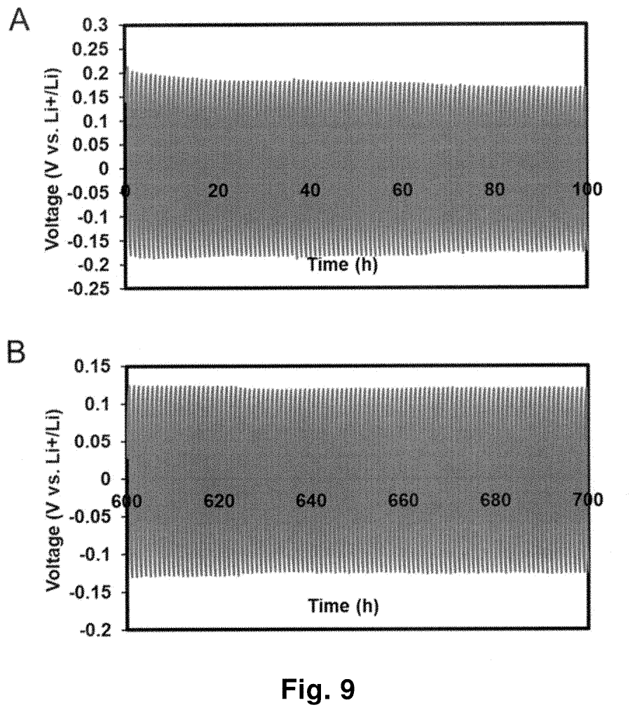

A result is shown in FIG. 9. It was confirmed that the coin cell stably performed the charge and discharge even after 100 hours according to A of FIG. 9 and even after 700 hours according to B of FIG. 9. Further, comparing A and B of FIG. 9, a voltage is attenuated in B of FIG. 9. However, the voltage attenuation was very gentle. Therefore, when the composite material 1 is used for a secondary cell, it is expected that the secondary cell has a long life.

### Example 13

### [LSV Measurement of Composite Material 1]

The LSV was performed using the composite material 1 produced in Example 10. The measurement was performed in the same manner as in Example 8 except that the sample was the composite material 1.

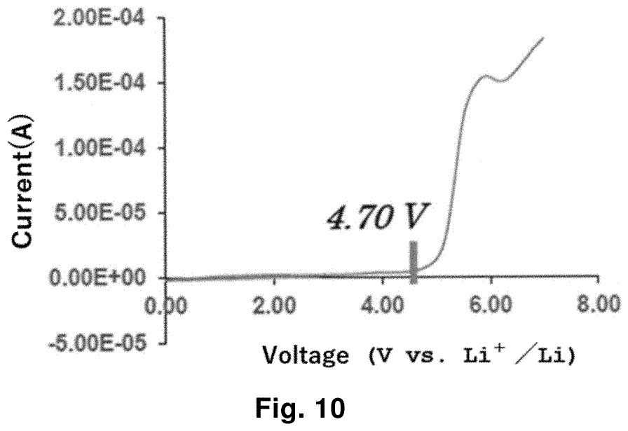

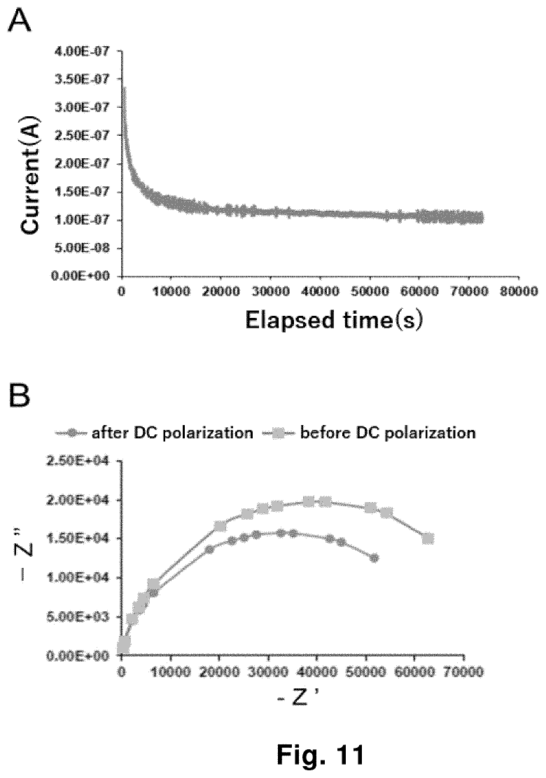

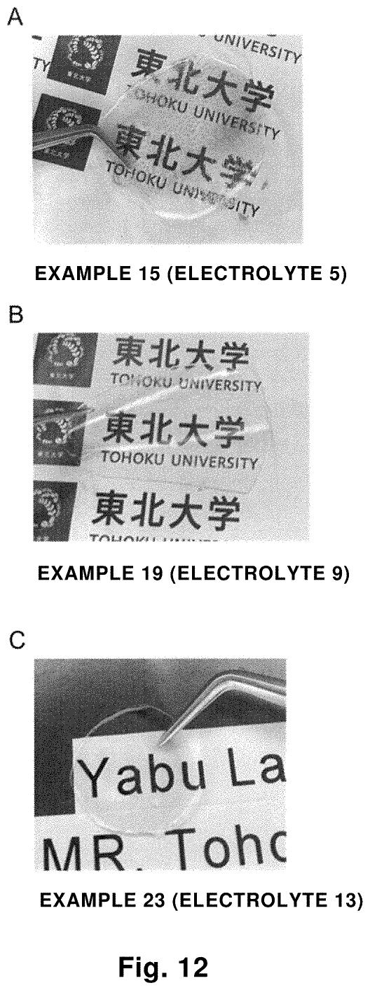

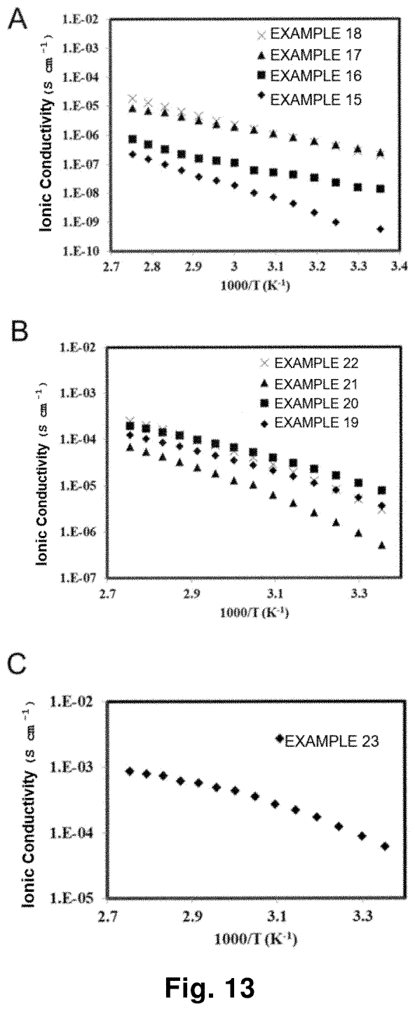

Results are shown in FIG. 10. It was shown from FIG. 10 that the composite material 1 was stable up to around 4.7 V. Based on the above, it was shown that the composite material 1 had a wide potential window. In addition, it was shown that the composite material had a wider potential window than that of only the electrolyte (Example 8).

### Example 14

### [Calculation of Li⁺ Transference Number of Composite Material 1]

The chronoamperometry and the AC impedance measurement were performed using the composite material 1 produced in Example 10, and a Li⁺ transference number of the composite material was calculated. The calculation of the Li⁺ transference number was performed in the same manner as in Example 9 except that the sample was the composite material 1.

Results of the chronoamperometry are shown in A of FIG. 11. Results of the AC impedance measurement are shown in B of FIG. 11. When t_{Li+} of the composite material 1 was calculated from the results shown in A and B of FIG. 11, t_{Li+} of the composite material 1 was 0.416.

### Example 15 to Example 23

### [Production of Electrolytes 5 to 13]

Electrolytes 5 to 13 were produced in the same procedure as in Example 1, except that each material was used in an addition amount shown in the following Table 1 during the production of the electrolyte. [EO]/[Li⁺] of the obtained electrolytes 5 to 13 are also shown in Table 1.

TABLE 1

| | | PEGDA | | | Li[TFSI] | Tetraglyme | DMPA | |
|---|---|---|---|---|---|---|---|---|
| | | Average | | Addition | Addition | Addition | Addition | |
| | | molecular | | amount | amount | amount | amount | |
| | | weight | n | [ml] | [g] | [ml] | [mg] | [EO]/[Li⁺] |
| Example 15 | Electrolyte 5 | 250 | 3 | 1.0 | 0.57 | 0.44 | 20 | 6 |
| Example 16 | Electrolyte 6 | 250 | 3 | 1.0 | 0.29 | 0.22 | 20 | 12 |
| Example 17 | Electrolyte 7 | 250 | 3 | 1.0 | 0.19 | 0.12 | 20 | 18 |
| Example 18 | Electrolyte 8 | 250 | 3 | 1.0 | 0.14 | 0.11 | 20 | 24 |
| Example 19 | Electrolyte 9 | 575 | 10 | 1.0 | 0.83 | 0.64 | 8.9 | 6 |
| Example 20 | Electrolyte 10 | 575 | 10 | 1.0 | 0.41 | 0.32 | 8.9 | 12 |
| Example 21 | Electrolyte 11 | 575 | 10 | 1.0 | 0.28 | 0.21 | 8.9 | 18 |
| Example 22 | Electrolyte 12 | 575 | 10 | 1.0 | 0.21 | 0.16 | 8.9 | 24 |
| Example 23 | Electrolyte 13 | 1000 | 20 | 1.0 | 0.95 | 0.74 | 5.0 | 6 |

The produced electrolytes 5, 9, and 13 are shown in FIG. 12. All of electrolytes 5, 9, and 13 having different average molecular weights of the used PEGDA were transparent, and maintained shapes thereof even when being held with tweezers. Since the shapes of electrolytes 5, 9, and 13 were maintained even when electrolytes 5, 9, and 13 are held by the tweezers, it is considered that electrolytes 5 to 13 have sufficient mechanical strength.

### Example 24

### [Temperature Dependence of Ionic Conductivities of Electrolytes 5 to 13]

Ionic conductivities of electrolytes 5 to 13 produced in Examples 15 to 23 were measured at a plurality of temperatures. The measurement was performed in the same manner as in Example 5 except that the sample was electrolytes 5 to 13.

The ionic conductivities of electrolytes 5 to 13 produced in Examples 15 to 23 measured at the respective temperatures are shown in FIG. 13. A of FIG. 13 shows the results of electrolytes 5 to 8 using PEGDA having an average molecular weight of 250 (n is up to 3). B of FIG. 13 shows the results of electrolytes 9 to 12 using PEGDA having an average molecular weight of 575 (n is up to 10). C of FIG. 13 shows the result of electrolyte 13 using PEGDA having an average molecular weight of 1000 (n is up to 20). Electrolytes 5 to 13 exhibited linearity in a measurement range. In addition, it was shown that electrolytes 5 to 13 had sufficient ionic conductivities. In addition, it was shown that the ionic conductivity of the electrolyte tends to increase as the average molecular weight of the used PEGDA increases.

From the above results, it was shown that the electrolyte disclosed in the present application has sufficient flexibility without being damaged even when the electrolyte is bent. In addition, it was shown that the composite material using the electrolyte is more stable as compared with when only the electrolyte is used, and has a high transference number.

### INDUSTRIAL APPLICABILITY

The electrolyte disclosed in the present application can provide an electrolyte having stretchability and flexibility. In addition, the electrolyte can be used for a cell, and thus is useful in the technical field of handling cells.

### REFERENCE SIGN LIST

1 secondary cell
2 positive electrode
3 electrolyte layer
4 negative electrode
5 positive electrode current collector
6 positive electrode active material layer
7 negative electrode current collector
8 negative electrode active material layer

1. An electrolyte comprising:
a polymer obtained by polymerizing a monomer represented by the following Formula (1) 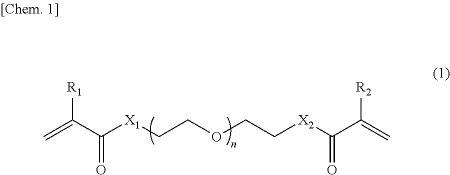
(In Formula (1), R₁ and R₂ each independently represent H or a linear, branched, or cyclic alkyl group having 1 to 20 carbon atoms. X₁ and X₂ each independently represent O or NH. When X₂ is O, n represents an integer of 0 to 30 on average, and when X₂ is NH, n represents an integer of 1 to 30 on average.);
a glyme represented by the following Formula (2) 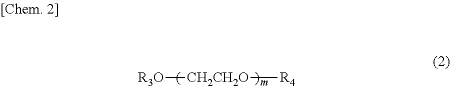
(In Formula (2), R₃ and R₄ each independently represent an alkyl group having 1 to 4 carbon atoms, and m represents an integer of 1 to 4.); and
at least one salt selected from the group consisting of a lithium salt, a sodium salt, a magnesium salt, a potassium salt, and a calcium salt.

2. The electrolyte according to claim 1, wherein
an anion of the salt is at least one selected from the group consisting of PF₆⁻, BF₄⁻, ClO₄⁻, B(C₂O₄)₂⁻, N(FSO₂)₂⁻, and N(CF₃SO₂)₂⁻.

3. The electrolyte according to claim 2, wherein
the anion of the salt is N(FSO₂)₂⁻ or N(CF₃SO₂)₂⁻.

4. The electrolyte according to claim 1, wherein
the salt is a lithium salt.

5. The electrolyte according to claim 1, wherein
in Formula (1), when X₂ is O, n is 3 to 14 on average, and when X₂ is NH, n is 4 to 15 on average.

6. The electrolyte according to claim 1, wherein
in Formula (2), m is 4.

7. A secondary cell at least comprising:
a positive electrode;
a negative electrode; and
an electrolyte layer between the positive electrode and the negative electrode, wherein
the electrolyte layer is the electrolyte according to claim 1.

8. A composite material comprising:
the electrolyte according to claim 1; and
a porous carrier.

9. The composite material according to claim 8, wherein
the porous carrier has a through hole penetrating in a thickness direction.

10. The composite material according to claim 8, wherein
the porous carrier is a honeycomb film.

11. A secondary cell at least comprising:
a positive electrode;
a negative electrode; and
an electrolyte layer between the positive electrode and the negative electrode, wherein
the electrolyte layer is the composite material according to claim 8.

12. The electrolyte according to claim 2, wherein
the salt is a lithium salt.

13. The electrolyte according to claim 3, wherein
the salt is a lithium salt.

14. The electrolyte according to claim 2, wherein
in Formula (1), when X₂ is O, n is 3 to 14 on average, and when X₂ is NH, n is 4 to 15 on average.

15. The electrolyte according to claim 3, wherein
in Formula (1), when X₂ is O, n is 3 to 14 on average, and when X₂ is NH, n is 4 to 15 on average.

16. The electrolyte according to claim 4, wherein
in Formula (1), when X₂ is O, n is 3 to 14 on average, and when X₂ is NH, n is 4 to 15 on average.

17. The electrolyte according to claim 12, wherein
in Formula (1), when X₂ is O, n is 3 to 14 on average, and when X₂ is NH, n is 4 to 15 on average.

18. The electrolyte according to claim 13, wherein
in Formula (1), when X₂ is O, n is 3 to 14 on average, and when X₂ is NH, n is 4 to 15 on average.

19. The electrolyte according to claim 2, wherein
in Formula (2), m is 4.

20. The electrolyte according to claim 3, wherein
in Formula (2), m is 4.
